(19) United States
(12) Patent Application Publication
(10) Pub. No.: US 2013/0081996 A1
(43) Pub. Date: Apr. 4, 2013

(54) FILTER ELEMENT

(71) Applicants: Nathaniel Royce Kamp, Peoria, IL (US); Christopher Joseph Salvador, Peoria, IL (US); Jeffrey Robert Ries, Metamora, IL (US)

(72) Inventors: Nathaniel Royce Kamp, Peoria, IL (US); Christopher Joseph Salvador, Peoria, IL (US); Jeffrey Robert Ries, Metamora, IL (US)

(21) Appl. No.: 13/617,999

(22) Filed: Sep. 14, 2012

Related U.S. Application Data
(60) Provisional application No. 61/542,007, filed on Sep. 30, 2011.

(51) Int. Cl. B01D 29/58; B23P 11/00

(52) U.S. Cl. 210/489; 29/428

(57) ABSTRACT

A filter element is disclosed. The filter element may include a first endcap. The filter element may also include a second endcap spaced from the first endcap along a central axis of the filter element. The filter element may also include an inner filter stage, which may include a first filter media that is disposed axially between the first and second endcaps and extends around the central axis of the filter element. Additionally, the filter element may include an outer filter stage, which may include a second filter media that is disposed axially between the first and second endcaps and extends around the inner filter stage. A radially inner portion of the second filter stage may adjoin a radially outer portion of the inner filter stage.

### RELATED APPLICATIONS

This application is based on and claims the benefit of priority from United States Provisional Application No. 61/542,007, filed Sep. 30, 2011, the contents of which are expressly incorporated herein by reference.

### TECHNICAL FIELD

The present disclosure relates to filtering fluids and, more particularly, to multistage filtering.

### BACKGROUND

Many systems filter fluids to remove contaminants from the fluid. For example, fuel systems, lubrication systems, and hydraulic systems often include one or more filters that remove contaminants from the fluid. Some such systems include a first filter element disposed in a first filter housing connected in series with a second filter element disposed in a second filter housing. Fluid flows through the first filter element in the first filter housing and then through the second filter element in the second filter housing. Such a multistage filtering system helps promote filtering efficiency. However, the proliferation of separate filter elements and housings may increase the cost and size of the filtering system.

U.S. Pat. No. 7,527,739 to Jiang et al. (“the '739 patent”) discloses a fuel water separator with a first filter media and a second filter media in one filter housing. The first filter media sits outside of the second filter media. The fuel water separator includes a cavity disposed between the first filter media and the second filter media. The '739 patent discloses that fuel flows radially inward through the first filter media into the cavity and from the cavity through the second filter media.

### SUMMARY

One disclosed embodiment relates to a filter element. The filter element may include a first endcap. The filter element may also include a second endcap spaced from the first endcap along a central axis of the filter element. The filter element may also include an inner filter stage, which may include a first filter media that is disposed axially between the first and second endcaps and extends around the central axis of the filter element. Additionally, the filter element may include an outer filter stage, which may include a second filter media that is disposed axially between the first and second endcaps and extends around the inner filter stage. A radially inner portion of the second filter stage may adjoin a radially outer portion of the inner filter stage.

Another embodiment relates to a filter element. The filter element may include a first endcap. The filter element may also include a second endcap spaced from the first endcap along a central axis of the filter element. Additionally, the filter element may include an inner filter stage. The inner filter stage may include a first filter media that is disposed axially between the first and second endcaps and extends around the central axis. The inner filter stage may also include reinforcing member wrapped around the first filter media. The filter element may also include an outer filter stage, which may include a second filter media that is disposed axially between the first and second endcaps and extends around the inner filter stage.

A further disclosed embodiment relates to a method making a filter element. The method may include placing an inner filter stage around a central axis, the inner filter stage including a first filter media. The method may also include placing an outer filter stage around the inner filter stage, such that a radially inner portion of the outer filter stage adjoins a radially outer portion of the inner filter stage, the outer filter stage including a second filter media. Additionally, the method may include attaching a first endcap to a first axial end of the inner filter stage and a first axial end of the outer filter stage. The method may also include attaching a second endcap to a second axial end of the inner filter stage and a second axial end of the outer filter stage.

### BRIEF DESCRIPTION OF THE DRAWINGS

FIG. 1 provides an axial cross-section of one embodiment of a filter element according to the present disclosure;

FIG. 2 provides a radial cross-section of one embodiment of a filter element according to the present disclosure;

FIG. 3 provides a perspective view of one embodiment of a filter element according to the present disclosure; and

FIG. 4 provides an axial cross-section of one embodiment of a filter element according to the present disclosure installed in an exemplary filter housing.

### DETAILED DESCRIPTION

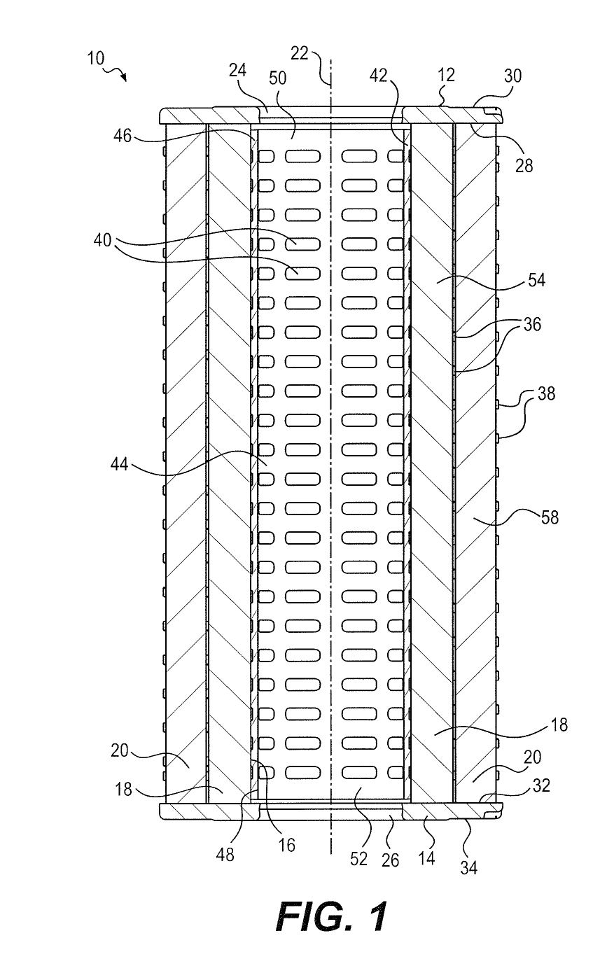

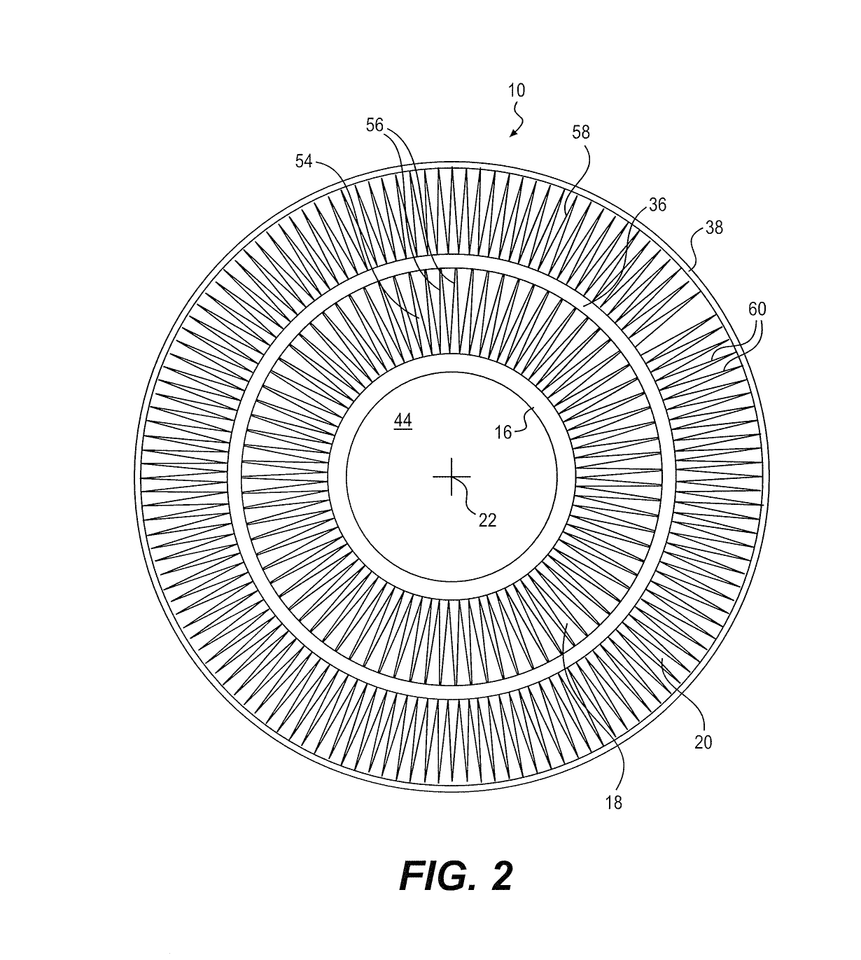

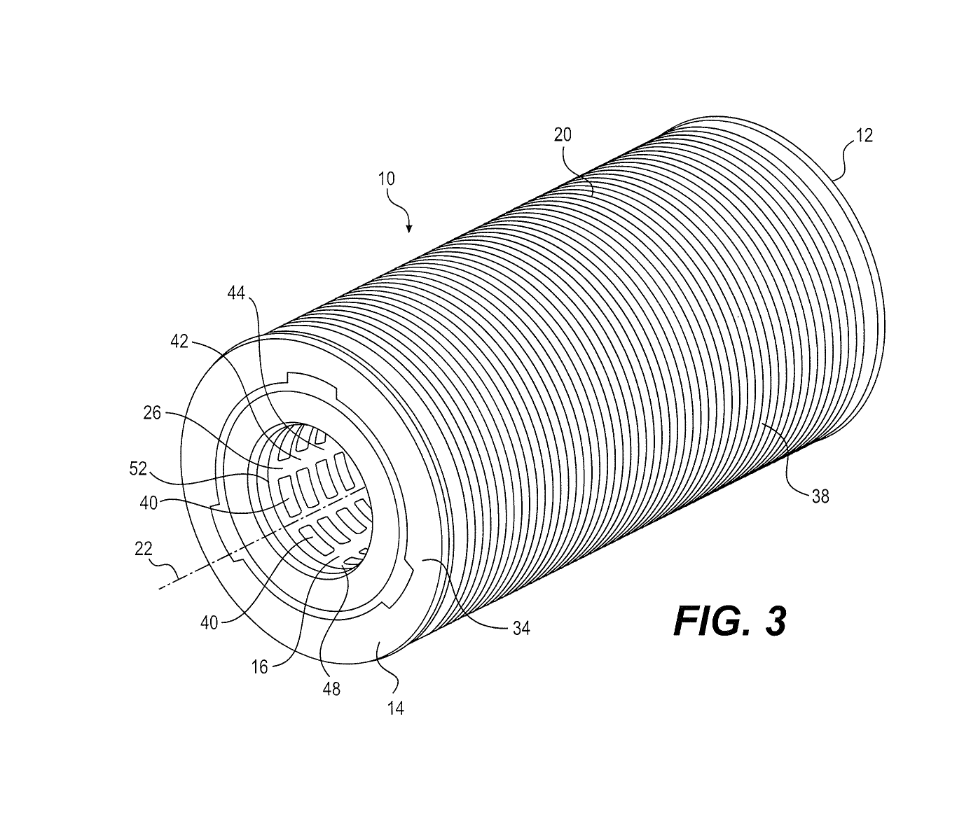

FIGS. 1-3 illustrate a filter element 10 according to the present disclosure. Filter element 10 may be any of various types of filter elements, including, but not limited to, a fuel filter, an oil filter, or a hydraulic filter. As best shown in FIG. 1, filter element 10 may include an endcap 12, an endcap 14, a center tube 16, an inner filter stage 18, and an outer filter stage 20. Center tube 16, inner filter stage 18, and outer filter stage 20 may extend along a central axis 22 of filter element 10. As shown in FIG. 2, center tube 16, inner filter stage 18, and outer filter stage 20 may also extend around central axis 22. Endcaps 12, 14 may be spaced from one another along central axis 22. Filter stages 18, 22 may be disposed axially between endcaps 12, 14.

Endcaps 12, 14 may have various configurations. In some embodiments, endcaps 12, 14 may be annular structures. Endcap 12 may include an inner surface 28 facing filter stages 18, 20, and an outer surface 30 opposite filter stages 18, 20. Similarly, endcap 14 may include an inner surface 32 facing filter stages 18, 20, and an outer surface 34 opposite inner surface 32. In the embodiment shown in the drawings, endcap 12 has an opening 24 in its center, and endcap 14 has an opening 26 in its center. Endcaps 12, 14 and openings 24, 26 thereof may be centered on central axis 22. Endcaps 12, 14 may be constructed of various materials. For example, in some embodiments, endcaps 12, 14 may be constructed of plastic.

Center tube 16 may include a wall 42 extending around central axis 22 and defining an open channel 44 along central axis 22. As best shown in FIG. 2, in some embodiments, wall 42 of center tube 16 may have a substantially circular cross-section around central axis 22. As best shown in FIG. 1, center tube 16 may have ends 46, 48. Ends 46, 48 may include openings 50, 52 that allow fluid to flow along central axis 22 into or out of the open channel 44 inside center tube 16. Additionally, in some embodiments, center tube 16 may have the openings 50, 52 in its ends 46, 48 in fluid communication with the openings 24, 26 in endcaps 12, 14. This may allow fluid to flow between the open channel 44 inside center tube 16 and the openings 24, 26 in endcaps 12, 14. Center tube 16 may also have a configuration that allows fluid to flow radially (relative to central axis 22) through center tube 16. For example, in the embodiments shown in the drawings, center tube 16 may include openings 40 in wall 42. Center tube 16 may be constructed of various materials. In some embodiments, center tube 16 may be constructed of a plastic material. Center tube 16 may be connected to various other components of filter element 10 in various ways. In some embodiments, center tube 16 may have its ends 46, 48 fixedly secured to endcaps 12, 14.

Endcaps 12, 14 and center tube 16 are not limited to the configurations shown in the drawings and discussed above. The shapes of endcaps 12, 14 and center tube 16 may differ in various ways from those shown in the drawings. For example, one or both of endcaps 12, 14 may not have a central opening 24, 26, such that they close a corresponding end 46, 48 of center tube 16. Additionally, endcaps 12, 14 and/or center tube 16 may be constructed of different materials, such as metals.

Filter stage 18 may be disposed between endcaps 12, 14 and extend around center tube 16. Filter stage 18 may include a filter media 54. Filter media 54 may take various forms. In some embodiments, filter media 54 may be a sheet of material folded into longitudinal pleats 56 (i.e., pleats whose folds extend parallel to central axis 22), as best shown in FIG. 2. Filter media 54 may include any material or materials configured to filter fluid. In some embodiments, filter media 54 may include cellulose material, spun polyester, or any other material suitable for filtering purposes. Filter media 54 may include a single layer of filter material, such as cellulose filter material. Alternatively, filter media 54 may include multiple layers of filter material integrally constructed. For example, filter media 54 may include a base of cellulose material with a coating of melt-blown polyester.

In addition to filter media 54, filter stage 18 may include a reinforcing member 36. Reinforcing member 36 may be disposed radially outward of filter media 54. Reinforcing member 36 may include any structure or structures that extend around filter media 54 and provide support therefor without blocking fluid flow through filter media 54. Thus, reinforcing member 36 may include various types of structural members that leave openings for fluid to flow through. In some embodiments, reinforcing member 36 may include one or more cords wrapped circumferentially around filter media 54 at axial intervals. For example, reinforcing member 36 may include a cord, such as roving, wrapped helically around filter media 54. Reinforcing member 36 may be secured to filter element 10 in various ways. In some embodiments, reinforcing member 36 may be glued to filter media 54 and/or other portions of filter element 10.

Filter stage 20 be disposed between endcaps 12, 14 and extend around filter stage 18. Similar to filter stage 18, filter stage 20 may include a filter media 58 and reinforcing member 38. Filter media 58 may be separate and separable from (i.e., not integrally attached to) filter media 54. Like filter media 54, filter media 58 may include any material or materials configured to filter fluid, and filter media 58 may include a single layer or multiple layers of filter material integrally affixed to one another. In some embodiments, filter media 58 may be constructed of the same filter material as filter media 54. Filter media 58 may have various forms. In some embodiments, filter media 58 may include a sheet of material folded into longitudinal pleats 60. For example, filter media 58 may include a sheet of cellulose material folded into pleats 60. Similar to reinforcing member 36, reinforcing member 38 may be disposed around radially outer portions of filter media 54. Like reinforcing member 36, reinforcing member 38 may include any structure or structures that extend around filter media 54 and provide support therefor without blocking fluid flow through filter media 54. Thus, reinforcing member 38 may include various types of structural members that leave openings for fluid to flow through. For example, reinforcing member 38 may be a cord, such as roving, helically wound around and glued to filter media 58.

A radially inner portion of filter stage 20 may adjoin a radially outer portion of filter stage 18. For example, in some embodiments, radially inner ends of the pleats 60 of filter media 58 may abut radially outer surfaces of reinforcing member 36. Reinforcing member 36 may help ensure that pleats 60 of filter media 58 do not slide between pleats 56 of filter media 54.

Filter stages 18, 20 may be secured in filter element 10 in various ways. In some embodiments, filter stage 18 may be secured to filter element 10 by affixing one axial end of filter media 54 to inner surface 28 of endcap 12 and affixing the other axial end of filter media 54 to inner surface 32 of endcap 14. Filter stage 20 may similarly be secured to filter element 10 by affixing the axial ends of filter media 58 to inner surfaces 28, 32 of endcaps 12, 14.

Filter media 54 and filter media 58 may have any dimensions suitable for the application of filter element 10. The radial dimension of pleats 56 may be similar to or different from the radial dimension of pleats 60. In the embodiment shown in the drawings, pleats 56 and pleats 60 have substantially the same radial dimensions. Additionally, the number of pleats 56 may be substantially the same as or different from the number of pleats 60. As shown in FIG. 2, in some embodiments, filter element 10 may have fewer pleats 56 than pleats 60. The total surface area of filter media 54 may be similar to or different from the total surface are of filter media 58. In some embodiments, the total surface area of filter media 58 may be greater than the total surface area of filter media 58. For example, in the embodiment shown in the drawings, because filter media 58 has more pleats 60 of substantially the same radial dimension as the pleats 56 of filter media 54, filter media 58 may have more total surface area than filter media 58. In applications where fluid flows across outer filter stage 20 before flowing across inner filter stage 18, providing filter media 58 with greater total surface area may prove beneficial because filter media 58 may have to capture more contaminants than filter media 54.

Filter element 10 is not limited to the configuration shown in the drawings and discussed above. For example, filter media 54 and filter media 58 may have different sizes of pleats 56 and 60, different numbers of pleats 56 and 60, and different total surface areas than the configuration shown in the drawings. Additionally, filter media 54 and/or filter media 58 may be constructed of materials other than those discussed above. Furthermore, one or both of filter stages 18, 20 may omit reinforcing members 36, 38. Additionally, filter element 10 may include other filter stages, in addition to filter stages 18, 20. Moreover, filter element 10 may omit center tube 16.

Filter element 10 may be assembled in various ways. One approach for assembling filter element 10 may involve wrapping filter media 54 of filter stage 18 around center tube 16. Subsequently, reinforcing member 36 may be wrapped around and glued to filter media 54. Then, filter media 58 of filter stage 20 may be wrapped around and against reinforcing member 36 of filter stage 18, and reinforcing member 38 may be wrapped around and glued to filter media 58.

Endcaps 12, 14 may be secured to filter stages 18, 20 and center tube 16 in various ways. In some embodiments, filter stages 18, 20 may be secured to endcaps 12, 14 by embedding the ends of filter media 54 and filter media 58 in endcaps 12, 14. For example, inner surfaces 28, 32 of endcaps 12, 14 may be heated to a molten state, and the ends of filter media 54 and filter media 58 may be inserted into the molten material and held there until the inner surfaces 28, 32 solidify with the filter media 54 and the filter media 58 embedded. Endcaps 12, 14 may be secured to ends 46, 48 of center tube 16 by means such as gluing. However, methods of making filter element 10 are not limited to these examples. For instance, different approaches may be used to secure the various components to one another.

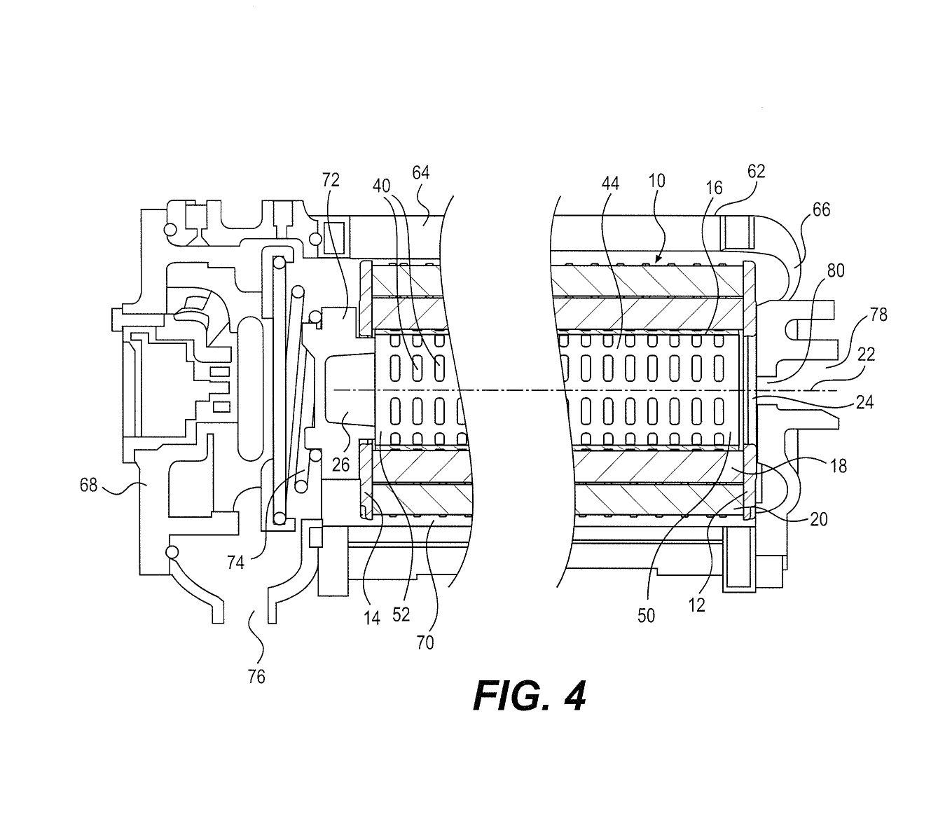

Filter element 10 may be used in various systems. FIG. 4 shows filter element 10 installed in a filter housing 62. Filter housing 62 includes a center section 64 and endcaps 66, 68. Center section 64 includes a chamber 70. One or more filter elements 10 may be disposed in chamber 70. In some embodiments, a single filter element 10 may be disposed in chamber 70. In other embodiments, multiple filter elements 10 may be installed in chamber 70. For example, multiple filter elements may be placed end-to-end (with their endcaps 12, 14 abutted against one another) in chamber 70. Adjacent endcap 68, filter housing 62 may include a plug 72 biased toward endcap 66 by a spring 74. Plug 72 may engage an endcap 14 of a filter element 10 in a manner to seal opening 26 in endcap 14. Additionally, spring 74 and plug 72 may urge the one or more filter elements 10 toward endcap 66, pressing an endcap 12 of the filter element 10 adjacent endcap 66 into sealing engagement with an inner surface of endcap 66. Filter housing 62 may have an inlet 76 in fluid communication with portions of chamber 70 radially outward of the one or more filter elements 10. Additionally, endcap 66 may include an outlet 78 in fluid communication with an opening 80 adjacent the opening 24 of the filter endcap 12 pressed against the inner surface of endcap 66.

Systems employing filtering element 10 are not limited to the configuration shown in FIG. 4. For example, a filter housing may have its inlet and outlet disposed in different positions than shown in FIG. 4. Additionally, different provisions may be used to hold filter elements 10 in position and to seal filter elements 10 within the filter housing. Furthermore, in addition to the filter housing 70 and filter elements 10 shown in FIG. 4, a system may include additional filter housings and filter elements, which may be connected in series or in parallel with the filter housing 70 and filter elements 10.

### INDUSTRIAL APPLICABILITY

Filter element 10 may have use in any application requiring filtering of fluid. Fluid may be filtered by directing it through filter stages 18, 20 of filter element 10. For example, in the case of the system shown in FIG. 10, fluid (e.g., fuel) may be directed into filter housing 62 via inlet 76, through the filter stages 18, 20 of the one or more filter elements 10, and out of filter housing 62 via outlet 78. After flowing through inlet 76, the fluid may flow into the portions of chamber 70 radially outward of filter elements 10. From there, the fluid may flow radially inward through filter stage 20, through filter stage 18, through center tube 16, and into channel 44 inside of the filter element 10. From channel 44, the fluid may flow through opening 80 to outlet 78.

The disclosed embodiments may provide a number of advantages. Constructing filter elements 10 with two filter stages 18, 20 may provide a compact, cost-effective means for performing multistage filtering of fluid. Placing the radially inner portion of the outer filter stage 20 in a position adjoining the radially outer portion of the inner filter stage 18 may provide for a particularly compact filter element 10. Additionally, placing the filter stages 18, 20 in adjoining relationship may help ensure that the filtered fluid flows seamlessly from one filter stage 18, 20 to the next without stagnation and turbulence between the filter stages 18, 20. This configuration may also allow the inner filter stage 18 to help support the outer filter stage 20 against radially inward forces resulting from fluid flowing inward across filter stage 20. Including reinforcing members 36, 38 around filter media 54, 58 may also help support filter stages 18, 20.

It will be apparent to those skilled in the art that various modifications and variations can be made in the disclosed systems and methods without departing from the scope of the disclosure. Other embodiments of the disclosed systems and methods will be apparent to those skilled in the art from consideration of the specification and practice of the systems and methods disclosed herein. It is intended that the specification and examples be considered as exemplary only, with a true scope of the disclosure being indicated by the following claims and their equivalents.

What is claimed is:

1. A filter element, comprising:
a first endcap;
a second endcap spaced from the first endcap along a central axis of the filter element;
an inner filter stage, the inner filter stage including a first filter media that is disposed axially between the first and second endcaps and extends around the central axis of the filter element;
an outer filter stage, the outer filter stage including a second filter media that is disposed axially between the first and second endcaps and extends around the inner filter stage, wherein a radially inner portion of the outer filter stage adjoins a radially outer portion of the inner filter stage.

2. The filter element of claim 1, wherein the inner filter stage includes a reinforcing member radially outward of the first filter media.

3. The filter element of claim 2, wherein the first filter media includes longitudinally pleated filter media.

4. The filter element of claim 3, wherein the second filter media includes longitudinally pleated filter media.

5. The filter element of claim 4, wherein the outer filter stage includes a reinforcing member radially outward of the second filter media.

6. The filter element of claim 4, wherein the second filter media has greater surface area than the first filter media.

7. The filter element of claim 4, wherein:
the first filter media is affixed at one end to the first endcap and at an opposite end to the second endcap; and
the second filter media is affixed at one end to the first endcap and at an opposite end to the second endcap.

8. The filter element of claim 1, wherein the first filter media is constructed of substantially the same material as the second filter media.

9. A filter element, comprising:
a first endcap;
a second endcap spaced from the first endcap along a central axis of the filter element;
an inner filter stage including
a first filter media that is disposed axially between the first and second endcaps and extends around the central axis, and
a reinforcing member wrapped around the first filter media; and
an outer filter stage including a second filter media that is disposed axially between the first and second endcaps and extends around the inner filter stage.

10. The filter element of claim 9, wherein the first filter media includes longitudinally pleated filter media.

11. The filter element of claim 10, wherein the second filter media includes longitudinally pleated filter media.

12. The filter element of claim 11, wherein the outer filter stage includes a reinforcing member radially outward of the second filter media.

13. The filter element of claim 11, wherein the second filter media has greater surface area than the first filter media.

14. The filter element of claim 11, wherein:
the first filter media is affixed at one end to the first endcap and at an opposite end to the second endcap; and
the second filter media is affixed at one end to the first endcap and at an opposite end to the second endcap.

15. The filter element of claim 9, wherein the second filter media is constructed of substantially the same material as the first filter media.

16. A method of making a filter element, the method comprising:
placing an inner filter stage around a central axis, the inner filter stage including a first filter media;
placing an outer filter stage around the inner filter stage, such that a radially inner portion of the outer filter stage adjoins a radially outer portion of the inner filter stage, the outer filter stage including a second filter media;
attaching a first endcap to a first axial end of the inner filter stage and a first axial end of the outer filter stage; and
attaching a second endcap to a second axial end of the inner filter stage and a second axial end of the outer filter stage.

17. The method of claim 16, wherein the inner filter stage includes a reinforcing member radially outward of the first filter media.

18. The method of claim 17, wherein placing the inner filter stage around the central axis includes placing the inner filter stage around a center tube.

19. The method of claim 17, wherein placing the outer filter stage around the inner filter stage includes wrapping the outer filter stage around and against the reinforcing member of the inner filter stage.

20. The method of claim 16, wherein placing the outer filter stage around the inner filter stage includes wrapping the second filter media around and against the inner filter stage.
